(19) United States
(12) Patent Application Publication
(10) Pub. No.: US 2004/0208306 A1
(43) Pub. Date: Oct. 21, 2004

(54) Method for realizing a telecommunications service in an intellegent communications network, which connects at least one first and second telecommunications terminal, and method for implementing in a communications system

(76) Inventors: Tania Abdel Hafez, Eichenau (DE); Can Davutoglu, A-Wien (AT); Peter Moritz, Haar (DE); Thomas Pfortner, Hohenkirchen (DE)

Correspondence Address: MORRISON & FOERSTER LLP, 1650 TYSONS BOULEVARD, SUITE 300, MCLEAN, VA, 22102, US

(21) Appl. No.: 10/484,580

(22) PCT Filed: Jul. 25, 2002
(86) PCT No.: PCT/EP02/08308

(30) Foreign Application Priority Data
Jul. 26, 2001 (DE) 01117703.7

(51) Int. Cl. H04M 7/00

(52) U.S. Cl. 379/219

(57) ABSTRACT

The invention relates to a method for realizing a telecommunications service in an intelligent communications net work (IN) (2), which connects at least one first and one second telecommunications terminal (1, 3), involving the use of a controlling service center (4), whereby the telecommunications service establishes (S8) a first connection and a second connection that is requested by the first and/or another telecommunications terminal after the first connection was disconnected. The invention also relates to a telecommunications system for implementing said method.

### CLAIM FOR PRIORITY

This application claims priority to International Application No. PCT/EP/02/0830 which was published in the German language on Feb. 6, 2003, which claims the benefit of priority to European Application No. EP 011 177 03.7, which was filed in the German language on Jul. 26, 2001.

### TECHNICAL FIELD OF THE INVENTION

The invention relates to a method for implementing a telecommunications service in an intelligent communications network which connects at least one first and one second telecommunications terminal, and a system for performing the method in a communications system.

### BACKGROUND OF THE INVENTION

Telecommunications services in communications networks include further services also offered by the network in addition to the basic services such as data transmission. Known services are, for example, the option of making available specific call numbers for service users, the use of which results in different call billing charges, as well as Virtual Private Networks (VPN) or Universal Personal Telecommunications (UPT).

In public networks, these services can be implemented in specific centralized devices—such as high-performance computers. Existing services are therefore modified and new services introduced only at centralized control points. An example of such centralized service control is the intelligent network (IN), the basic architecture of which has been standardized by ETSI (European Telecommunication Standards Institute) and ITU-T (International Telecommunications Union) according to the Q.1200 series.

The basic concept of the intelligent network is the separation of switching functions and service functions. The mechanisms that establish a connection are no longer all located in the individual switching point but are centralized in a powerful computer, also referred to as a service center, from-which they can easily be modified. Corresponding data is forwarded from here to local switching points, which control the further establishment of the connection there.

Hitherto, it was only possible to offer new services for users when the user's local exchange had been upgraded for such purposes. This resulted in expensive upgrade methods and long lead times when new services were introduced. With the solution of centralized control of the modification and/or introduction of services. However, it is no longer necessary to retrofit the individual switching points.

When a telecommunications service is called within an intelligent network, the call is implemented by means of a connection request on the part of a network user. To do this, the user selects a service number, e.g. an IN prefix (“01”) and a service code (“80”). An IN-compatible switching point (SSP, Service Switching Point) can detect the existence of an IN service from the selected number sequence “0180” by comparing it with the content of a cross-service trigger table. The content of the trigger table is predefined by the network operator and can be modified. As well as the selection of the service number, connection states such as for example “busy”, “no reply” and “pick up handset” can also function as triggers.

If the switching point is not designed for use in intelligent networks, a connection is established by means of a predefined connection route to an IN switching point assigned to it and the selected number sequence is transmitted to this as a parameter.

Once the existence of an IN service has been detected in the switching point, the service selected by means of the IN service code starts to operate as a function of an application program assigned to it, which is selected by means of the trigger table. The service is set up by the application program in a service center (SCP, Service Control Point) and controls the further handling of the call. This operational sequence is described in the ITU-T recommendation Q.1214.

One possible operational sequence of the telecommunications service can be the announcement of an announcement device of the IN, the announcement device being disposed for example in an Intelligent Peripheral (IP) which allows the user to manage the service. By choosing from a software menu the user can then selectively query the desired information from the announcement device. The Intelligent Peripheral can also respond to a request from the user using a first calling terminal to establish a connection to a second terminal. The user who is then called by means of the telecommunications service and who is using the second terminal can however not change the connection using the service.

### SUMMARY OF THE INVENTION

The present invention discloses a method for implementing an IN telecommunications service which is initiated without a call of a service user and which allows any terminal using the IN service to change a connection.

In one aspect of the invention, the telecommunications service is first activated by a first telecommunications terminal in the service center and then started by an automatically executed data comparison without the involvement of the first terminal. Then during a call implemented by the service at least a first connection is established with the intelligent network, which connection a user using the terminal can clear down again if they wish in order to have a second connection established.

It is therefore not necessary to use a call from the terminal in order to start the service within the intelligent network which causes an announcement message to be sent to the first and further terminals. Rather, the service automatically initiates the announcement mode after its activation by the first terminal by means of an application program (also called IN Service Logic) after an automatic start based on a previously executed data comparison.

The first connection is preferably established between an announcement device or a further communications device of the intelligent network and the first and/or at least one further terminal, while the second connection is established between the first and/or further terminal and a second and/or further terminal. The second and/or further terminal can hereby also be configured as a different form of telecommunications device, such as for example a private automatic branch exchange or a facility representing a call center.

For such an automatic start of the service, according to a preferred embodiment the application program is activated by a trigger, the trigger being activated or started in the form of a “virtual call number”, which is first generated by the center and transmitted to a service provider within the intelligent network. This “virtual call number” serves to be detected as a service call in an IN-compatible switching point (SSP) and to be forwarded by the SSP to the service center (SCP) to execute the application program. The “virtual call number” can, for example, then be sent to the switching point if a data comparison produces a positive result. This means that the service which was hitherto initiated by a connection set-up request on the part of the first terminal can be started by a different type of event.

During activation of the telecommunications service, reference data is input by the first terminal, the user of which subsequently appears as one of the service users. The reference data can be divided into connection data and content data. Connection data includes, for example, the telephone numbers of the terminals to be called by means of the service, while content data includes the data that is compared in the data comparison to be performed later with data transmitted by the second terminal. The starting of the service is made dependent on the result of the comparison. In addition to this data, parameters are also input such as input formats, time specifications, and conditions which are intended to prevent the starting of the service. Multiple call numbers for the various terminals of the user who activated the service at the start via the first terminal can also be input. This ensures the user can be reached in the event of a call to be performed subsequently by means of the service.

After the start of the service, the application program located in the service center calls the first and further terminals in order to establish a first connection with these to an announcement device of the intelligent network, which device can be embodied for example in an Intelligent Peripheral. After they have received a predefined announcement message which is based on the comparison results, the users are requested by the service center via the IP to send a first message about the requested establishment of the second connection to the second terminal to the service center. By this means they can initiate a change of the connection which existed previously with the announcement device. The service center then initiates the clear-down of the first connection and the establishment of the second connection between the first and further terminals on the one hand and the second terminal on the other hand via the switching device.

A second message including request signals to request the transmitted data and/or the comparison results or further data is sent by the first and/or further telecommunications device to the service center. This second message, which can also be sent before the first message from the time viewpoint, gives a service user the option for example to query cancellation data which is necessary to cancel the flight.

According to a preferred embodiment, the messages about the requested establishment of the second connection can be queried by the service center using a voice memory system such as Interactive Voice Response (IVR). Terminal users can then easily signal the message to the service center by a keystroke.

To implement the method, in another embodiment, a telecommunications system with a service center in an intelligent communications network (IN) advantageously has a first storage device for storing the application program, a second storage device for storing reference data and further activation data, a comparison device for comparing the content data contained in the reference data with the transmitted data, and devices for establishing and clearing down the first or second connection.

### BRIEF DESCRIPTION OF THE DRAWINGS

Additional advantages and uses can be derived from the description below in conjunction with the drawings, in which:

FIG. 1 shows a schematic representation of the method including aspects of the device, and FIGS. 2a and 2b show a flow diagram of an embodiment of the method.

### DETAILED DESCRIPTION OF THE INVENTION

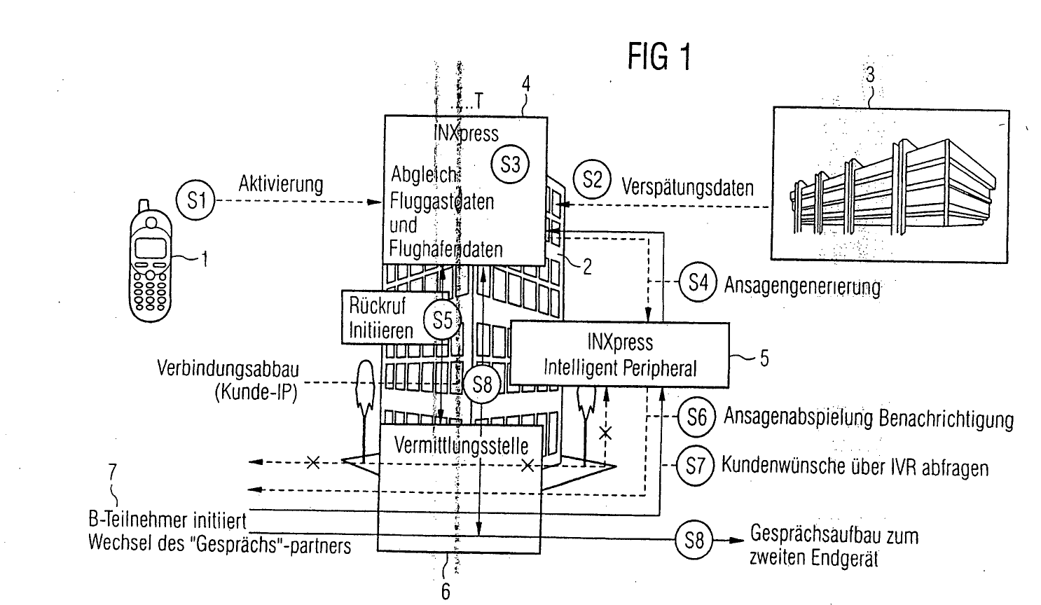

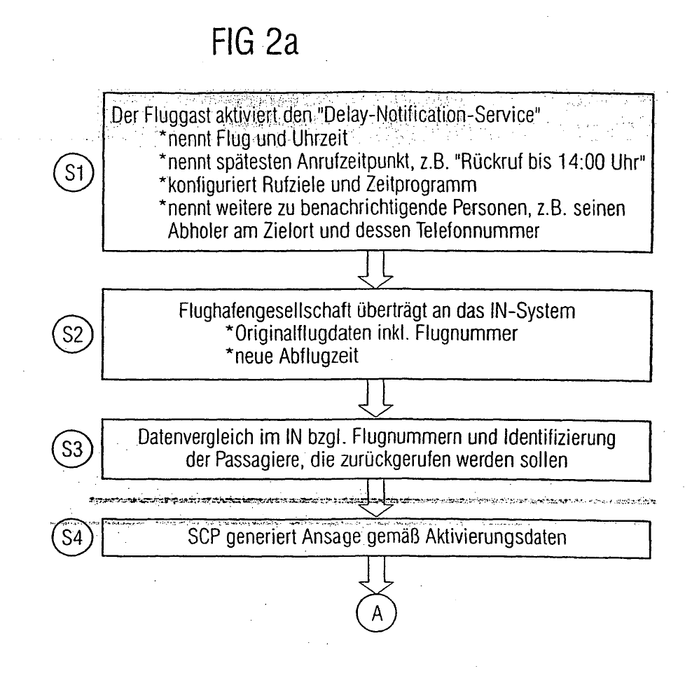

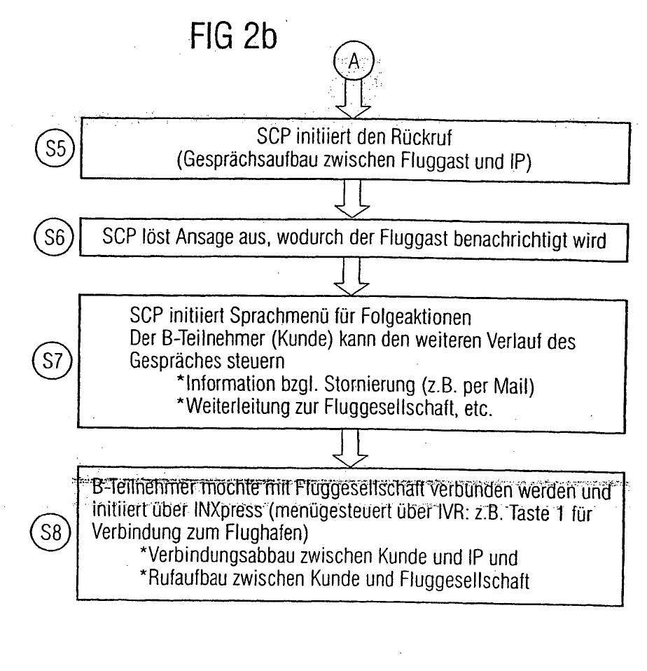

FIG. 1 shows a communications network IN which has the capability to implement services provided on a centralized basis. A first terminal 1 is connected, as is a second terminal 3, to an intelligent network 2 via a service center 4 (SCP). The application program which represents the service logic of the service is set up in the service center 4.

An announcement device of the IN is connected via an intelligent peripheral 5 to the service center 4 and a switching point 6 (SSP) which is configured for intelligent networks. Further terminals 7 are connected to the intelligent network via the switching point 7.

In S1 the user using the first terminal 1 activates the service in the service center 4 by transmitting reference data. The reference data comprises connection data about those connections via which information, in particular announcement messages, are to be sent, and content data, which is used for a data comparison. The service center 4 thus receives the necessary data for the later implementation of the services, such as for example the telephone numbers of the activating user and further telephone numbers of further users, so that their terminals can be called later. The telephone numbers are included in the connection data. Content data, on the other hand, includes the data to be compared, on the basis of the result of which comparison the telecommunications service starts.

The service center 4 uses this data to generate a “virtual call number” as a trigger which serves to start the service. This virtual call number is then sent to a service provider (not shown here) or another suitable communications device which can be connected to the second terminal 3. Alternatively in an inquiry mode data from the second terminal can be interrogated by means of the service center 4 (S2) and when the relevant data is available, the actual telecommunications service can be started.

Once the transmitted data is available in S3, this is compared with the content data which was input during the activation process. If the comparison results predefined by the service are available, in S4 an announcement message is generated by the service center and in S6 the announcement message is transmitted via the announcement device and the switching point 6 to the terminals to be called. For this a call controlled by the service center 4 is made to each of the terminals 7 (S5).

With the announcement message the users of the terminals 7 are requested to specify whether they wish to change this first connection to the announcement device. If the users using the terminals 7 agree to this in an IVR method, for example by means of a keystroke (S7), the first connection to the announcement device is cleared down and a second connection to the terminal 3 is set up by the switching point 6 and the service center 4 (S8).

FIGS. 2a and 2b show the flow diagram of an embodiment of the method according to the invention using the example of an information service for air travelers. This information service for air travelers is intended to provide information in the event of delays. For this purpose the air traveler activates a “Delay Notification Service” in the service center (S1) by transmitting a flight number, the date and time of departure to the service center as content data. The air traveler also specifies the latest call time, for example by inputting “callback by 14:00 hrs”. The air traveler also configures call destinations as connection data, which can for example be a person with a terminal who is due to collect him at the arrival point. He can also specify further call numbers of additional terminals belonging to him.

In S2, a call center of an airline company transmits the original flight data including the flight number and the new departure times after notification of a delay to the intelligent network. In S3, a data comparison takes place in the service center with regard to flight numbers and the ID of passengers who are to be called back. In such a data comparison, a check is first carried out in the service center to establish whether there is an inquiry on the part of the user using the first terminal relating to the specific flight number. If this check has a positive result, a storage table is accessed which contains the flight times assigned to the respective flight number as content data. If a comparison of these flight times leads to the conclusion that the flight is subject to a delay outside a predefined time frame, all the call numbers are accessed which the user transmitted before as connection data during the activation process. In S,4 the service center then generates an announcement message, the content of which relating to the delayed departure is to be forwarded to each of these call numbers.

In S5, the service center initiates calls to the air traveler's terminal and the terminals of further users by setting up a connection between the intelligent peripheral in which the announcement device is located and the terminals.

In S6, the service center then starts the send process to send the announcement message to the air traveler and further users.

In S7, the service center uses a software menu to initiate a voice memory system (IVR) which provides an inquiry mode to enable the further users and the air traveler to receive further information relating to a cancellation of the flight, for example by email. Users of the further terminals are also requested to send a message about a requested establishment of a second connection between the terminals of the air traveler or the further users and the call center of the airline to the service center. If the further users have sent such a connection setup request in the form of a message to the service center, a storage area containing different call numbers which is located in the service center is accessed. Depending on the respective user expressing such a connection setup request, a call number data record is then assembled which can also include, for example, the call number of the German Railways information service which can be used as an alternate connection for the delayed flight connection. If users decide in favor of a second connection to the airline during the selection performed by means of the software menu INXpress, in a step S8 this connection is established by means of INXpress. In addition the first connection between the terminals of the users and the intelligent peripheral is cleared down. The users can thus independently initiate a change of connections.

What is claimed is:

1. A method for implementing a telecommunications service in an intelligent communications network which connects at least one first and one second telecommunications terminal, with a controlling service center comprising:
activating the telecommunications service in the service center by the first telecommunications, and
starting the telecommunications service by comparison results resulting from a data comparison, wherein the data comparison takes place between reference data stored in the service center which is transmitted during the activation by the first telecommunications device and data transmitted by the second terminal, and the telecommunications service establishes a first connection and a second connection requested by at least one user of at least the first telecommunications terminal after the first connection has been cleared down.

2. The method according to claim 1, wherein the first connection is established between at least the first telecommunications terminal and an announcement device and/or a further communications device of the intelligent network and the second connection is established between at least the first telecommunications terminal and at least the second telecommunications terminal.

3. The method according to claim 1, wherein at least the first telecommunications terminal sends a first message via the first connection to the service center about the requested establishment of the second connection and the clear down of the first connection.

4. The method according to claim 3, wherein a second message includes request signals to request at least one of the transmitted data, the comparison results or further data, and is sent by at least the first telecommunications terminal to the service center.

5. The method according to claim 3, wherein the messages are input via a voice menu provided by an intelligent peripheral of the telecommunications service.

6. The method according to claim 1, wherein the service center generates an announcement message as a function of the comparison results and transmits the announcement message to the announcement device, and the announcement device transmits the announcement message to at least the first telecommunications terminal.

7. The method according to claim 1, wherein upon activation of the telecommunications service, additional information of at least the first telecommunications terminal is input to establish the first connection.

8. The method according to claim 2, wherein the message is interrogated at at least the first telecommunications terminal by the telecommunications service by a voice memory system.

9. The method according to claim 2, wherein the message is signaled to the service center by a keystroke on a keyboard of at least the first telecommunications terminal.

10. A Telecommunications system with a service center in an intelligent communications network, comprising:
a first storage device to store an application program to be executed for implementation of a telecommunications service;
a second storage device to store reference data for the telecommunications service;
receiving devices to receive reference data and data transmitted by a second telecommunications terminal;
a comparison device to compare the transmitted data with the stored reference data;
first devices to establish and clear down a first connection between at least a first telecommunications terminal and an announcement device and/or a communications device of the intelligent network; and
second devices to establish a second connection between at least the first telecommunications terminal and at least the second telecommunications terminal.

11. The telecommunications system according to claim 10, further comprising a voice memory system to send a voice request to input messages and to detect the one message input by at least the first telecommunications terminal by voice or keystroke.

12. The telecommunications system according to claim 11, further comprising a software menu to set up the voice memory system in the service center and at least the first telecommunications terminal.
